(19) United States
(12) Patent Application Publication
(10) Pub. No.: US 2003/0152694 A1
(43) Pub. Date: Aug. 14, 2003

(54) Optical element and method for manufacturing the same

(76) Inventors: Leif Bergstedt, Sjomarken (SE); Bjorn Loving, Goteborg (SE)

Correspondence Address: STERNE, KESSLER, GOLDSTEIN & FOX PLLC, 1100 NEW YORK AVENUE, N.W., WASHINGTON, DC, 20005, US

(21) Appl. No.: 10/338,027

(22) Filed: Jan. 8, 2003

Related U.S. Application Data
(60) Provisional application No. 60/346,977, filed on Jan. 11, 2002.

(51) Int. Cl. B05D 5/06

(52) U.S. Cl. 427/162

(57) ABSTRACT

The present invention relates to a method for producing an optical element (10) and an optical element, preferably a refractive element, comprising a carrier (11) and an clement part (12). Said element part comprises at one layer (15a, 15b, 15c) selectively deposited on said substrate trough a printing operation.

### TECHNICAL FIELD OF THE INVENTION

The present invention relates to a method for producing an optical element, preferably a refractive element, comprising a carrier and an element par. The invention also relates to optical elements produced through the method.

### BACKGROUND OF THE INVENTION

Microlenses and other refractive elements may for example be used for coupling light from a laser to an optical fibre and from the optical fibre to a photodetector.

A number of methods for manufacturing an array of micro-lenses are known. Example of some methods are discussed in patent literature, for example U.S. Pat No. 4,689,291, U.S. Pat. No. 6,071,652, 3JP 0660607 and JP 10123305 U.S. Pat. No. 5,536,455 and EP 614 096-A1.

According to U.S. Pat. No. 4,699,291, monolithic microlenses and microlens arrays are manufactured on opto-electronic devices and other substrates by using sharp edge pedestals to confine the lateral flow of a molten lens material. The lens material wets the upper surfaces of the pedestals, but the pedestal edges confine the flow, so the lens material conforms to the shape of the pedestal surface and assumes a semi-arcuate profile due to its surface tension. Spin coating and photolithographic patterning may be employed to form the pedestals and to deposit the lens material thereon. The lens material is melted after being deposited, so the pedestals advantageously are stabilized to prevent them from deforming at the temperature of the molten lens material.

In U.S. Pat. No. 6,071,652, grey scale masks used to create optical elements are formed. Desired grey scale patterns may be created by varying the thickness of a light-absorbing layer. Such variations in thickness may be created using multiple binary masks. Desired grey scale patterns may also be created on a computer using available software and then imaged onto film or a glass film plate. Direct contact or proximity printing is then used to transfer the true grey scale pattern onto photoresist. The photoresist is then etched, thereby forming the desired pattern therein. All portions of the desired pattern are simultaneously formed in the photoresist. The etched photoresist is then used to photolithographically fabricate either the optical element itself or a master element to be used in injection moulding or other replication techniques. The grey scale mask itself may be used repeatedly to generate photoresists. The imaging is particularly useful for forming optical elements having a plurality of arrays of refractive elements.

However, all of the above mentioned documents relate to providing a layer of an optically transparent layer, parts of which are removed in another step to form sections, which are melted to form micro-lenses.

### SUMMARY OF THE INVENTION

The main object of the present invention is present a novel method of manufacturing an optical element, preferably a refractive element such as one or several micro-lenses or gratings.

Advantages of the invention also involve allowing mass production of micro-lens arrays, gratings etc. with very good accuracy.

Therefore a method for producing an optical element, preferably a refractive element. comprising a carrier and an element part is provided. The method comprises selectively depositing on said substrate trough a printing operation at least one layer constituting said element part. According to one aspect of the Invention, said printing operation comprises one of offset printing, screen-printing, liquid jet printing or electrostatic printing. Preferably, the selective deposition comprises deposition of several layers of different characteristics or the layer may consist of different material. Thus, at least one layer is melted to form said element. The layer can be dot shaped for lenses and strip for a grating.

The invention also relates to an optical element, preferably a refractive element, comprising a carrier and an element part, wherein the element part comprises at lean one layer selectively deposited on said substrate through a printing operation.

### BRIEF DESCRIPTION OF THE DRAWINGS

In the following, the invention will be further described in a non-limiting way with reference to the accompanying drawings in which:

FIG. 1 schematically illustrates an embodiment of the invention comprising from above,

FIG. 2 illustrates a cross-section along line II-II in FIG. 1,

FIG. 3 illustrates a cross-sectional production step, and

FIG. 4 illustrates a cross-sectional view of another production step.

### DETAILED DESCRIPTION Of THE EMBODIMENTS

In the following, the invention will be described in a non-limited way with reference to micro-lenses, according to one aspect of the invention. However, it should be understood that other refractive elements fall within the scope of the invention. According to the main aspect of the invention, elements are produced using a printing method on a substrate, whereby a layer(s) of suitable material is disposed onto the substrate. The printing method may include any of modified versions of screen-printing, offset printing, electrostatic deposition or “fluid-jet” printing.

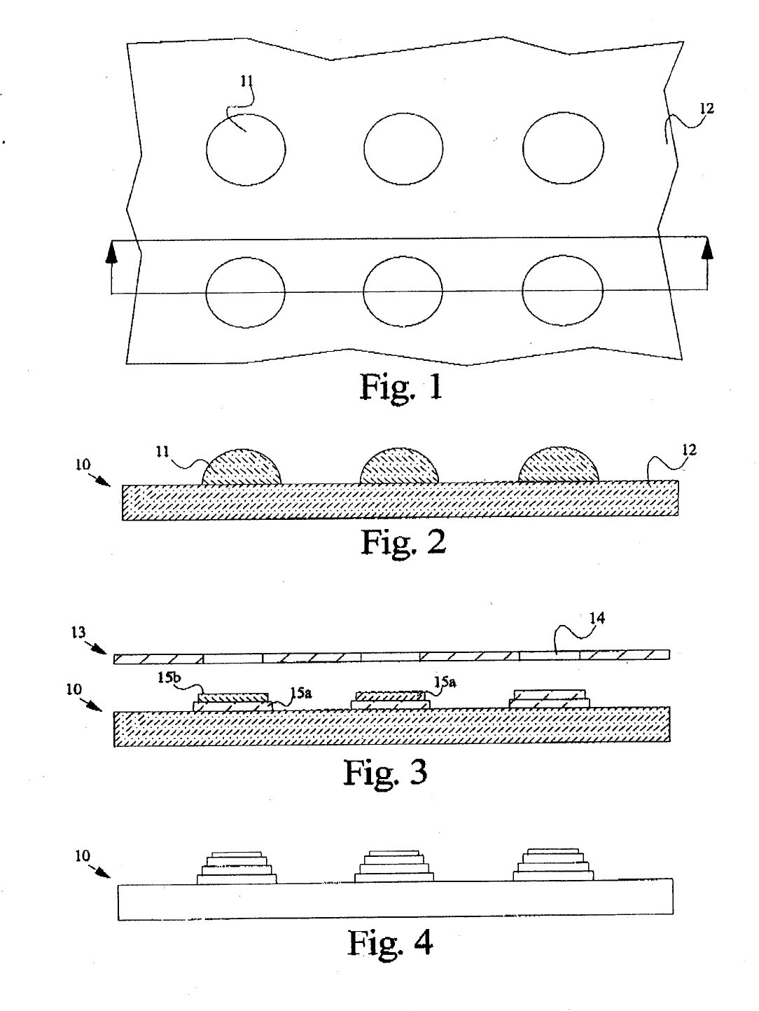

One preferred embodiment of the invention is illustrated in FIG. 1, which shows an array of micro-lenses 11 arranged on a substrate 12. FIG. 2 is a cross-section along line II-II in FIG. 2. The substrate 11 may consist of an optically transparent material such as glass or ceramic material.

One method of manufacturing the lenses is illustrated in FIGS. 3 and 4. In his example selective layers of an optically transparent material such as glass, plastic or the like are deposited in layers. In this case screen-printing is used to deposit the layers. Accordingly, patterns of lenses consisting of layers are applied to a screen 13, transferring onto the substrate only through the porous segments 14, The stacked layers are arranged in decreasing size so that a substantially pyramid shape is obtained. Each layer 15a, 15b and 15c can consist of same material or same material having different characteristics, such as different refractive indexes. In addition, different material such as plastic and glass can be combined.

Using selective multilayer deposition of glass, allows glass formations (lenses) having different viscosity/surface tension etc. Different characteristics and material types allow mass production of new types of optical elements.

When all stacks of layers are in place, each stack is exposed to heat, which melts/fuses the each stack of layer into a solid, substantially half spherical form, as illustrated in FIGS. 1 and 2.

The deposition of the layers can also be carried out using offset printing, in which melt glass (or plastic) is spread on a metal plate with etched patterns, then transferred to an intermediary surface and finally applied to substrate by pressing the it against the intermediary surface.

The invention is also suitable for producing other optical elements such as gratings. In this case oblong strips of glass/plastic are printed onto a substrate. instead of dots. Different types of material and material with different characteristics can be used to produce different strips on same substrate. Furthermore. different strips of different material can be printed in sequences to provide a desired grating. Also, one strip can include different material/characteristics. The surface of the strips can be treated, e.g. by grinding or polishing to obtain desired features.

In fluid jet or electrostatic printing method. melted or very small particles of glass/plastic are used, which are blown over the substrate or disposed through electrostatic.

The invention is not limited to the shown embodiments but can be varied in a number of ways without departing from the scope of the appended claims and the arrangement and the method can be implemented in various ways depending on application, functional units, needs and requirements etc.

1. A method for producing an optical element (10), preferably a refractive element, comprising a carrier (11) and an element part (12), characterised in
selectively depositing on said substrate through a printing operation at least one layer (15a, 15b,15c) constituting said element part.

2. The method of claim 1, wherein said printing operation comprises one of offset printing, screen-printing, liquid jet printing or electrostatic printing.

3. The method of claim 1, wherein said selective deposition comprises deposition of several layers of different characteristics.

4. The method according to any one of claims 1-4, wherein said at least one layer is melted to form said element.

5. The method according to any one of claims 1-3, wherein said layer is dot shaped.

6. The method according to any one of claims 1-3, wherein said layer is a strip.

7. The method according to claim 3, wherein said layer consists of different material

8. A lens element produced according to any of claims 1-7.

9. A microlens element produced according to any of claims 1-7.

10. A microlens array produced according to any of claims 1-7.

11. A grating element produced according to any of claims 1-7.

12. An optical element (10), preferably a refractive element, comprising a carrier (11) and an element part (12), characterised in
that said element pat comprises at least one layer (15a, 15b, 15c) selectively deposited on said substrate through a printing operation.

13. The optical element of claim 12, wherein said printing operation comprises one of offset printing, screen-printing, liquid jet printing or electrostatic printing.
